(19) United States
(12) Patent Application Publication
(10) Pub. No.: US 2006/0056304 A1
(43) Pub. Date: Mar. 16, 2006

(54) Methods, systems, modems, and computer program products for connection speed selection

(76) Inventor: Wayne Moore, Lawrenceville, GA (US)

Correspondence Address: CANTOR COLBURN LLP, 55 GRIFFIN ROAD SOUTH, BLOOMFIELD, CT, 06002, US

(21) Appl. No.: 10/941,435

(22) Filed: Sep. 15, 2004

(51) Int. Cl. H04L 12/26; H04L 12/66

(52) U.S. Cl. 370/252; 370/468; 370/352

(57) ABSTRACT

Methods, systems, modems, and computer program products provide a selection of different connection speeds and a service over a network at the selected connection speed. The service is billed according to the selected connection speed. For example, a user can select a connection speed for Internet access that is more than dial-up but less than DSL and only pay for the selected connection speed.

### FIELD OF THE INVENTION

The present disclosure relates generally to communications and in particular, to providing a selection of connection speeds for a service.

### BACKGROUND OF THE INVENTION

Consumers interested in Internet access have to choose between a slow, affordable connection speed, such as 56K dial-up, and a faster, more expensive connection speed, such as digital subscriber line (DSL). There is a need for ways to provide faster connection speeds that are affordable. There is a need for ways to provide other kinds of services at different speeds as well, where the service can be billed according to the selected speed.

### SUMMARY

Exemplary embodiments of the present invention include a system for connection speed selection that comprises a device, equipment, and a service provider. The device adapts a computing device to an outgoing signal. The device has a connection speed selector for selecting a selected connection speed from a plurality of connection speed selections. The equipment connects the outgoing signal to a network. The service provider is connected to the network and provides service to the computing device at approximately the selected connection speed.

Other exemplary embodiments of the present invention include a computer program product for connection speed selection. The computer program product includes a storage medium that is readable by a processor. The processor executes instructions stored on the storage medium to perform a method. The method includes receiving a selected connection speed over a network, where the connection speed is selected from a number of connection speeds and providing a service over the network at approximately the selected connection speed. One embodiment includes a web page indicating how long they've been using the particular connection and at what bandwidth they were using the bandwidth at that particular time.

Still other exemplary embodiments of the present invention include a computer program product for connection speed selection. The computer program product includes a storage medium that is readable by a processor. The processor executes instructions stored on the storage medium to perform a method. The method includes providing a selection from a number of connection speeds, providing a connection speed over a network that was selected from the connection speeds, and receiving a service over the network at approximately the selected connection speed.

Other systems, methods and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring to the exemplary drawings wherein like elements are numbered alike in the several FIGURES:

FIG. 1 is a block diagram of an exemplary system, including a first exemplary modem for connection speed selection, in accordance with embodiments of the present invention;

FIG. 2 is a front view of the first exemplary modem for connection speed selection in another exemplary system in accordance with embodiments of the present invention;

FIG. 3 is a rear view of the first exemplary modem for connection speed selection in yet another exemplary system in accordance with embodiments of the present invention;

FIG. 4 is a block diagram of an exemplary system, including a second exemplary modem for connection speed selection, in accordance with embodiments of the present invention;

FIG. 5A is a front view of the second exemplary modem for connection speed selection in accordance with embodiments of the present invention;

FIG. 5B is a rear view of the second exemplary modem for connection speed selection in accordance with embodiments of the present invention;

FIG. 6 is an exploded view of the second exemplary modem for connection speed selection in accordance with embodiments of the present invention;

FIG. 7 is an exploded view of the first exemplary modem for connection speed selection in accordance with embodiments of the present invention;

FIG. 8A is a front view of an alternate design for the first exemplary modem for connection speed selection in accordance with embodiments of the present invention;

FIG. 8B is a rear view of an alternate design for the first exemplary modem for connection speed selection in accordance with embodiments of the present invention; and

FIG. 8C is an exploded view of an alternate design for the first exemplary modem for connection speed selection in accordance with embodiments of the present invention.

### DETAILED DESCRIPTION OF EXEMPLARY EMBODIMENTS OF THE INVENTION

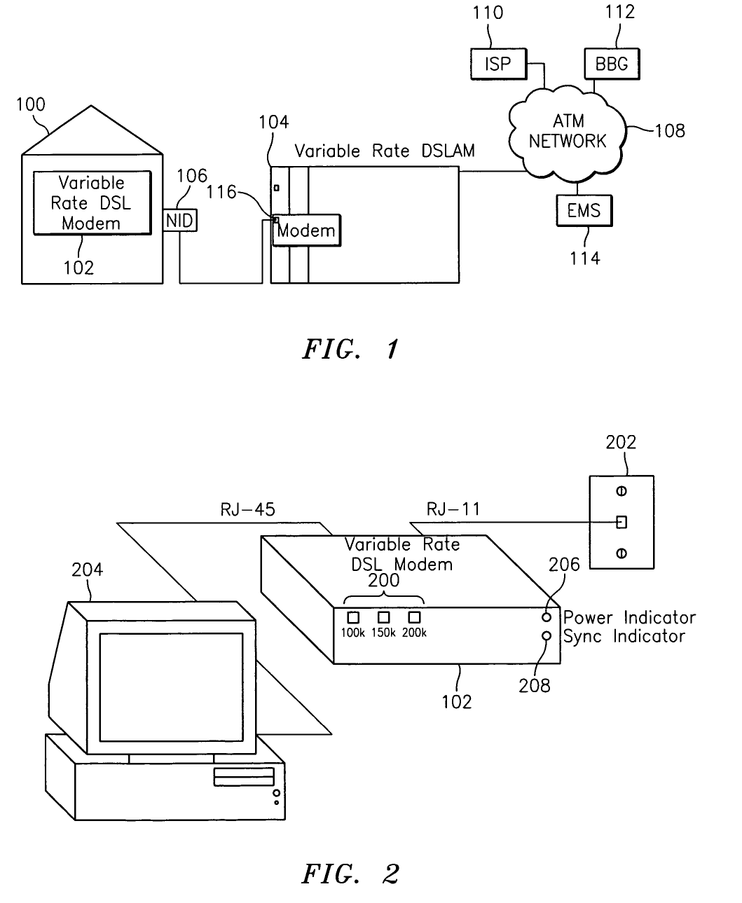

FIG. 1 shows an exemplary system, including a first exemplary modem for connection speed selection, in accordance with embodiments of the present invention. Many different kinds of modems may be adapted in accordance with embodiments of the present invention, even though exemplary modems are described herein. In this exemplary system, a variable rate DSL service is provided to a user. The user chooses the desired rate of DSL based, e.g., on what the user can afford. Other exemplary embodiments provide many different types of services, such as broadband, Internet, voice over Internet, wireless fidelity (WiFi), wireless, home entertainment, commerce, global positioning, satellite, dial up, and similar services to a wide range of users, such as businesses.

In this high level end-to-end example, the premises 100, e.g. the home of a user, has a variable rate DSL modem 102 connected to a variable rate digital subscriber line access multiplexor (DSLAM) 104 via a network interface device (NID) 106. The DSLAM 104 may be implemented in a central office (CO) or remote terminal (RT) and provide a connection from a telephone line to an Internet service. The NID 106 is a device that terminates copper pairs from the CO at the user's destination, and this device is typically located outside that location. The NID 106 also provides an interface between the user's equipment and the network. In other exemplary embodiments, various other transmission mediums, devices, modems, connecting equipment, interfaces, copper or fiber, and wired or wireless systems may be used.

In this example, the variable rate DSLAM 104 is connected to an Asynchronous Transfer Mode (ATM) network 108, which is, in turn, connected to an Internet service provider (ISP) 110, a broadband gateway (BBG) 112, and an element management system (EMS) 114. The ATM network 108 is a high-speed network protocol with a short packet length that is used for voice and video. The BBG 112 is an interface to a broadband communications network. The EMS 114 is a system that manages equipment and data, including managing the connection speed selected by the user. In other exemplary embodiments, various other types of networks, protocols, and systems are used, such as different element management systems like local craft terminal (LCT).

In this example, when the user selects a connection speed that connection speed is provided and the user is billed accordingly. For example, a user might choose a fast connection speed while downloading video and then change back to a slower speed to surf the Internet. In this case, the user would only be charged for the fast connection speed for the time downloading video. In this example, the connection speeds offered to the user may be somewhere in the range of dial-up to DSL, such as 56K 100K, 150K, 200K, 256K, each with an associated cost. Other embodiments provide other connection speed selections and associated billing schemes, such as promotions. In this example, the user selections are tracked by the EMS 114, which monitors a sync rate and amount of bandwidth used by the user. Of course, the amount of bandwidth varies depending on traffic and other factors, but approximately the selected connection speed is provided. For example, a connection speed varying within a range around the selected connection speed may be provided. In one embodiment, synchronization at the selected rate occurs at the DSLAM 104 and in another embodiment, synchronization occurs at the BBG 112. In one embodiment, the EMS 114 stores a profile containing the selected connection speed and other information about the user and the EMS provides billing information based on the selected connection speed. In another embodiment, the EMS stores a history of connection speeds.

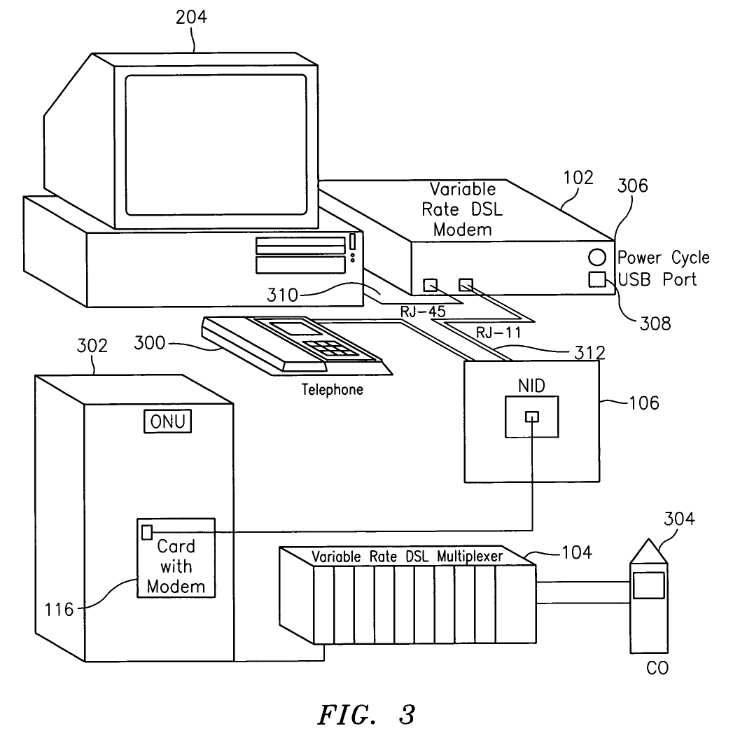

FIG. 2 shows the first exemplary modem for connection speed selection in another exemplary system in accordance with embodiments of the present invention. In FIG. 2, the variable rate DSL modem 102 is shown in more detail. In this example, the variable rate DSL modem 102 has buttons 200 for selecting 100K, 150K, and 200K connection speeds and has connections to a wall outlet 202 and a personal computer 204. Other embodiments have various selection options and various ways of selecting connection speeds, such as virtual buttons on a website. In one embodiment, a website receives a connection speed selection which is stored in the profile at the EMS 114 and used to provide and bill for Internet service through the ISP 110 at the selected connection speed at the variable rate DSL modem 102. In this embodiment, there is a web page indicating how long a user has been using the particular connection and at what bandwidth the user was using the bandwidth at that particular time. Advantageously, this will allow the user to know how much they have used and approximately what they will be charged.

In this exemplary embodiment, the variable rate DSL modem 102 also includes a power indicator 206 and a sync indicator 208. The power indicator 206 is a light emitting diode (LED) indicating that the variable rate DSL modem 102 has power. The sync indicator 208 indicates that the variable rate DSL modem 102 is synchronized with another modem 116 (FIG. 1). The power indicator 206 and sync indicator 208 are useful for troubleshooting.

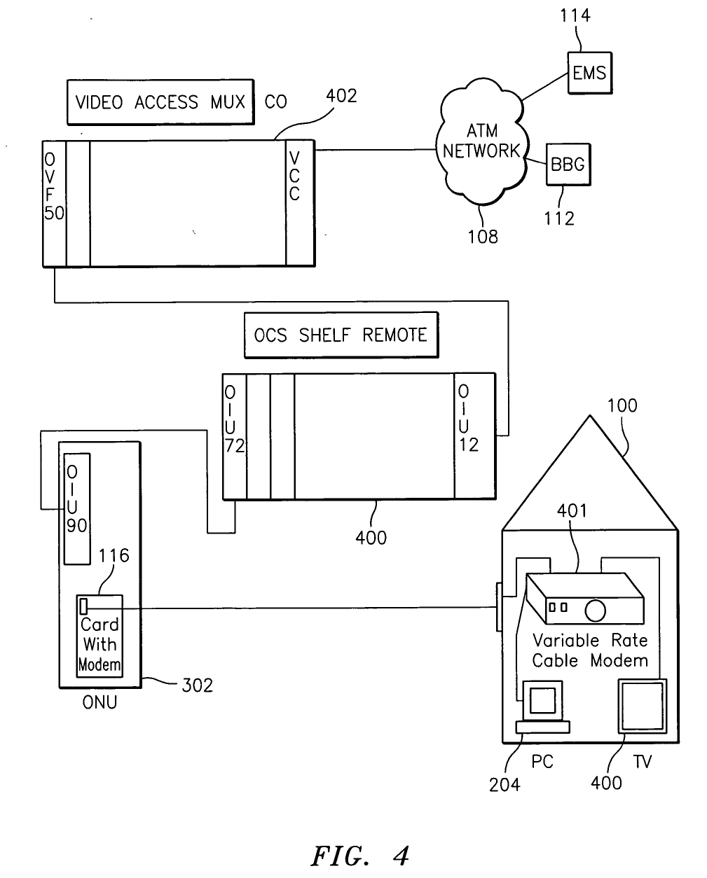

FIG. 3 shows a rear view of the first exemplary modem for connection speed selection in yet another exemplary system in accordance with embodiments of the present invention. In this detailed example, a variable rate fiber-fed DSL service is provided. This service is provided through a variable rate DSL modem 102, such as an asymmetric digital subscriber line (ADSL) modem or a high bit-rate digital subscriber line (HDSL). In other embodiments, various other kinds of modems are used. An ADSL modem transmits digital information at high bandwidths on existing telephone lines to homes and businesses. ADSL simultaneously accommodates both analog (voice) and digital data on the same line and provides a continuously available connection, using most of the channel to transmit downstream to the user and only a small part to receive information from the user. HDSL is used for wideband digital transmission within a corporate site and between the telephone company and a home or business. HDSL is symmetrical sot that an equal amount of bandwidth is available in both directions.

In this exemplary embodiment, the variable rate DSL modem 102 is connected to a personal computer 204 and a NID 106. The NID 106 is connected to a telephone 300 and an optical network unit (ONU) 302. An ONU is a device serving to terminate an optical circuit, e.g., at a user's premises, at the curb, or in the neighborhood. An ONU is one the primary elements of a full service optical network (FSAN). Various hybrid networks make use of ONUs to accomplish the interface between fiber optic feeder cables and metallic cables, converting optical signals to electrical signals and vice versa. The ONU is connected to the variable rate DSL multiplexor 104. The variable rate DSL multiplexor 104 is connected to a CO 304. The variable rate DSL modem 102 includes a power cycle 306, a USB port 308, an RJ-45 connection 310 to PC 204, and an RJ-11 connection 312 to the NID 106.

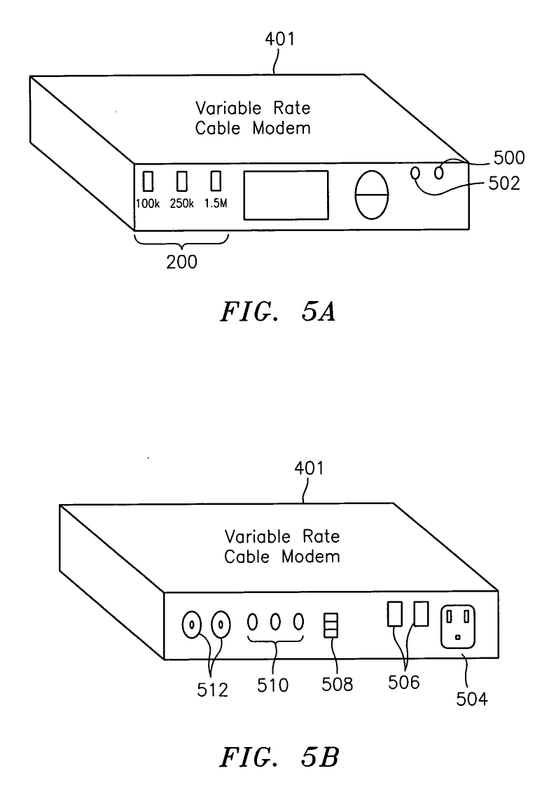

FIG. 4 shows an exemplary system, including a second exemplary modem for connection speed selection, in accordance with embodiments of the present invention. In this high level example, a user has a variable rate cable modem 401 in the user's premises 100, e.g., a home. The variable rate cable modem 401 is connected to a personal computer 204 and a television 400. The variable rate cable modem 401 is connected to an ONU 302. The ONU 302 is connected to an RT 400 that is connected to a video access multiplexor 402 at a CO. The video access multiplexor 402 is connected to ATM network 108. ATM network is connected to EMS 114 and BBG 112. Using this system, the user can select a connection speed for cable television and/or cable Internet service.

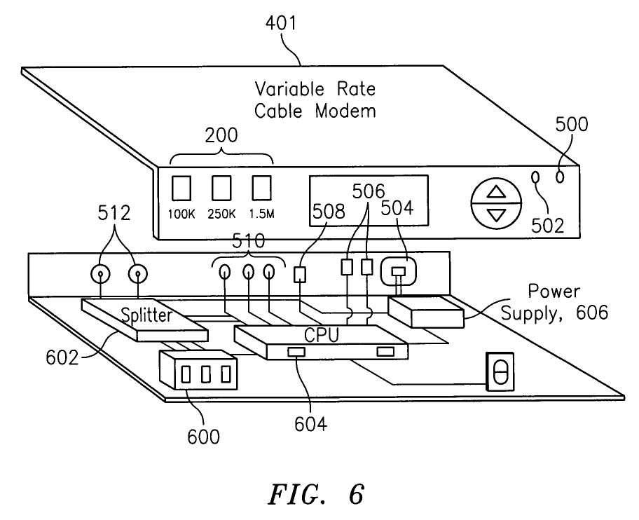

FIGS. 5A and 5B show the second exemplary modem for connection speed selection in accordance with embodiments of the present invention. In this detailed example, the variable rate cable modem 401 is shown in front and rear views. The front of the variable rate cable modem 401 has a power indicator 500, a sync status indicator 502, and connection speed selection buttons 200. In other embodiments, different connection speed selection systems and methods are used, such as selection from a web page. The back of the variable rate cable modem 401 has a power plug 504, connectors 506, USB port 508, RCA ports 510 for television, web cams or other devices, and connectors 512. Other embodiments have various other ports, connectors, selectors, and other features.

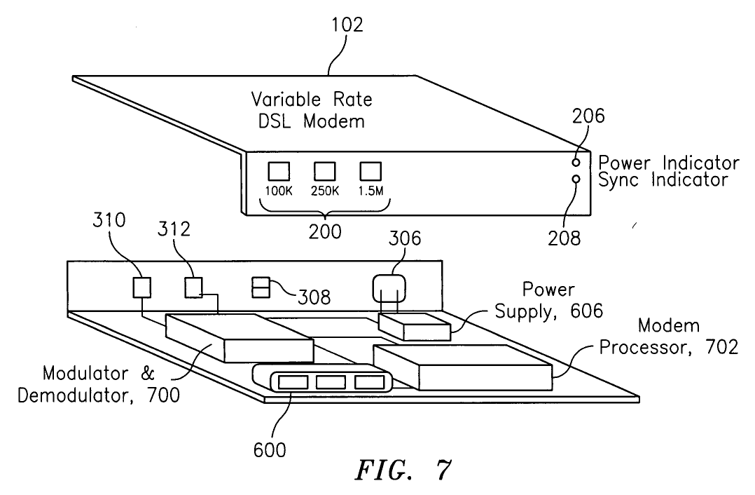

FIG. 6 shows an exploded view of the second exemplary modem for connection speed selection in accordance with embodiments of the present invention. In this example, the internal components of the variable rate cable modem 401 include touch sensitive pads 600, a cable modem splitter 602, a cable modem central processor unit (CPU) 604, and a power supply 606. The touch sensitive pads 600 correspond to the connection speed selection buttons 200. The cable modem splitter 602 includes a processor for splitting data signals from television signals coming in from one of the connectors 512 and combining before they go out through the other one of the connectors 512. The cable modem CPU 604 controls a data rate selected by the user and changes the user's profile. Other exemplary embodiments may implement these internal components differently, such as combining components or including other components, such as a communications module or may arrange interconnections differently. In this example, the components are implemented on a circuit board. Other exemplary embodiments may be adapted for various kinds of services, such as high definition television (HDTV).

In this exemplary embodiment, when the user selects a connection speed, the internal components of the variable rate cable modem 401 operate to make the change. After the user selects a connection speed using connection speed selection buttons 200, the cable modem CPU 604 sends a request to the EMS 114 (See FIG. 1) to change the user's profile. This request is sent through the cable modem splitter 602 so that it can be added to the data part of the outgoing signal and combined with the television part of the outgoing signal. A profile is a control file used by software associated with managing services for a user. The profile includes policies. A policy is a set of rules applied to the user's connection to offer a particular connection speed. A set of available policies is stored on the EMS 114 and the cable modem CPU 604 is capable of recognizing a policy received from the EMS 114. In response to the request, the EMS 114 applies the policy corresponding to the selected connection speed to the user's profile. Once the EMS 114 has applied the policy, the connection speed is changed for the user.

In this exemplary embodiment, the EMS 114 and cable modem CPU 604 communicate using at least one protocol. A protocol is a set of formal rules describing how to transmit data, especially across a network. Low-level protocols define the electrical and physical standards to be observed, bit- and byte-ordering, and the transmission and error-detection and correction of the bit stream. Both the EMS 114 and the cable modem CPU 604 have instructions in software, firmware, hardware or the like that enable communication, sending and receiving requests for a change in connection speed, applying a policy to a profile, synchronization, sending and receiving acknowledgements, storing data with time and date stamps, and so on.

In this exemplary embodiment, the cable modem CPU 604 includes storage for storing a profile sent from the EMS 114, tracking usage and changes in connection speed, and the like. For example, billing may be based on actual usage and connection speed data stored on the cable modem CPU 604 and sent to the EMS 114 periodically.

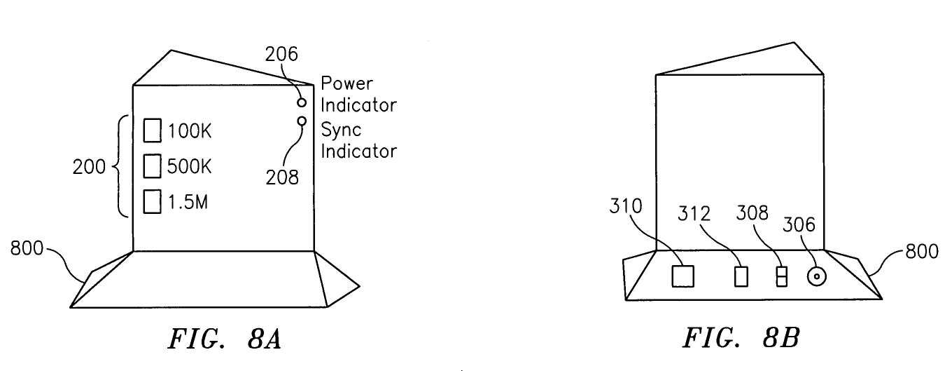

FIG. 7 shows an exploded view of the first exemplary modem for connection speed selection in accordance with embodiments of the present invention. A modem is a device for transmitting data, e.g., digital data, over telephone wires by modulating the data into an audio signal to send it and demodulating an audio signal into data to receive it. The variable rate DSL modem 102 includes a modulater/demodulater 700, touch sensitive pads 600, a modem processor 702, and a power supply 606.

In this exemplary embodiment, when the user selects a connection speed, the internal components of the variable rate DSL modem 702 operate to make the change. After the user selects a connection speed using touch sensitive pads 600, the modem processor 702 sends a request to the EMS 114 (See FIG. 1) to change the user's profile. The modulater/demodulater 700 sends and receives signals including such requests. In response to the request, the EMS 114 applies the policy corresponding to the selected connection speed to the user's profile. Once the EMS 114 has applied the policy, the connection speed is changed for the user.

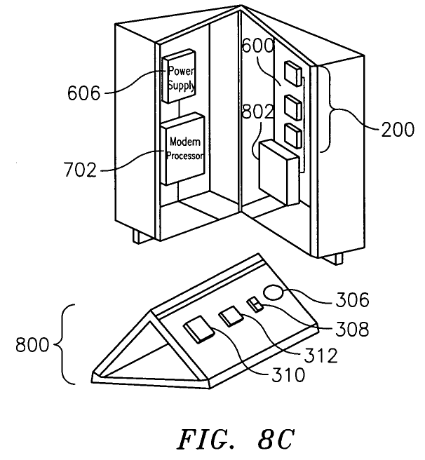

FIGS. 8A, 8B, and 8C are front, rear, and exploded views, respectively, of an alternate design for the first exemplary modem for connection speed selection in accordance with embodiments of the present invention. The variable rate DSL modem 702 has a modem stand 800 and an additional electrical component 802. Other components are arranged differently than in FIG. 7. The present invention encompasses many different designs with various components and arrangements of parts.

While the invention has been described with reference to exemplary embodiments, it will be understood by those skilled in the art that various changes may be made and equivalents may be substituted for elements thereof without departing from the scope of the invention. For example, communication using wireless technology, converting from analog to digital, modems adapted for HDTV, and other changes in the future can be made without departing from the conception of the invention described herein by reference to exemplary embodiments. In addition, many modifications may be made to adapt a particular orientation, situation, or material to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A system for connection speed selection, comprising:
a device for adapting a computing device to an outgoing signal, the device having a connection speed selector for selecting a selected connection speed from a plurality of connection speed selections;
equipment for connecting the outgoing signal to a network; and
a service provider connected to the network for providing service to the computing device at approximately the selected connection speed.

2. The system of claim 1, further comprising:
a profile accessible from the network for storing the selected connection speed.

3. The system of claim 2, further comprising:
a monitoring system for providing billing information based on the profile.

4. The system of claim 3, wherein the monitoring system updates the profile, in response to a change in the selected connection speed.

5. The system of claim 3, wherein the monitoring system stores a history of connection speeds and providing billing information based on both the profile and the history of connection speeds.

6. The system of claim 1, wherein the service provider provides a type of service selected from the group consisting of Internet access service, wireless service, cellular service, cable service, and satellite service.

7. The system of claim 1, wherein the device is a modem and the equipment for connecting the outgoing signal to the network includes:
a network interface device for receiving information from the outgoing signal; and
a central office interposed between the network interface device and the network.

8. The system of claim 7, wherein the central office includes a digital subscriber line (DSL) access multiplexor.

9. The system of claim 7, wherein the modem includes an indicator for indicating whether the modem is in sync with the equipment for connecting the outgoing signal to the network.

10. The system of claim 1, wherein the device is a cable modem and the equipment for connecting the outgoing signal to the network includes:
an optical network unit connected to the cable modem; and
a video access multiplexor interposed between the network and the optical network unit.

11. A computer program product for connection speed selection, the computer program product comprising:
a storage medium readable by a processor and storing instructions for execution by the processor for performing a method comprising:
receiving a selected connection speed from a plurality of connection speeds over a network; and
providing a service over the network at approximately the selected connection speed.

12. The computer program product of 11, wherein the method further comprises:
providing a selection from the plurality of connection speeds.

13. The computer program product of 11, wherein the method further comprises:
storing a profile accessible from the network, the profile including the selected connection speed.

14. The computer program product of 13, wherein the method further comprises:
providing billing information based on the profile.

15. The computer program product of 13, wherein the method further comprises:
updating the profile, in response to a change in the selected connection speed.

16. The computer program product of 13, wherein the method further comprises:
storing a history of connection speeds and providing billing information based on both the profile and the history of connection speeds.

17. The computer program product of 11, wherein the service is a type of service selected from the group consisting of Internet access service, wireless service, cellular service, cable service, and satellite service.

18. A computer program product for connection speed selection, the computer program product comprising:
a storage medium readable by a processor and storing instructions for execution by the processor for performing a method comprising:
providing a selection from a plurality of connection speeds;
providing a selected connection speed from the plurality of connection speeds over a network; and
receiving a service over the network at approximately the selected connection speed.

19. The computer program product of 18, wherein the service is a type of service selected from the group consisting of Internet access service, wireless service, cellular service, cable service, and satellite service.

20. The computer program product of 18, wherein billing for the service is according to the selected connection speed.

21. The computer program product of 18, wherein the method further comprises:
providing a web page for indicating at least one time of use at each particular bandwidth.

22. The computer program product of 21, wherein the web page includes a cost estimate.

23. A modem for connection speed selection, comprising:
a plurality of selectors for selecting a connection speed;
a splitter for sending and receiving cable signals and for splitting and combining data signals and television signals, said cable signals having data signals and television signals;
a processor for receiving a connection speed selection from said selectors and for sending and receiving messages in data signals to and from said splitter; and
a power supply for supplying power to said selectors, said splitter, and said processor.

24. The modem of claim 23, wherein said selectors are touch sensitive pads.

25. The modem of claim 23, further comprising:
an element management system for sending and receiving messages in said data signals in said cable signals to and from said processor and for applying a policy to a profile in response to a request to change a connection speed from said processor.

26. The modem of claim 23, wherein said processor sends billing information in said messages.

27. The modem of claim 23, further comprising:
a power indicator; and
a sync indicator.

28. A modem for connection speed selection, comprising:
a plurality of selectors for selecting a connection speed;
a modulater/demodulater for sending and receiving signals;
a processor for receiving a connection speed selection from said selectors and for sending and receiving messages in signals to and from modulater/demodulater; and
a power supply for supplying power to said selectors, said splitter, and said processor.

29. The modem of claim 28, wherein said selectors are touch sensitive pads.

30. The modem of claim 28, further comprising:
an element management system for sending and receiving messages to and from said processor and for applying a policy to a profile in response to a request to change a connection speed from said processor.

31. The modem of claim 28, wherein said processor sends billing information in said messages.

32. The modem of claim 28, further comprising:
a power indicator; and
a sync indicator.
